(19) United States
(12) Patent Application Publication
(10) Pub. No.: US 2015/0115876 A1
(43) Pub. Date: Apr. 30, 2015

(54) MOBILE ROBOT, CHARGING APPARATUS FOR THE MOBILE ROBOT, AND MOBILE ROBOT SYSTEM

(71) Applicant: LG ELECTRONICS INC., Seoul (KR)

(72) Inventors: Dongki NOH, Seoul (KR); Seungmin BAEK, Seoul (KR)

(21) Appl. No.: 14/529,774

(22) Filed: Oct. 31, 2014

(30) Foreign Application Priority Data
Oct. 31, 2013 (KR) 10-2013-0131623

(51) Int. Cl. H02J 7/00

(52) U.S. Cl. CPC H02J 7/0042
USPC 320/107

(57) ABSTRACT

A charging apparatus is configured to charge a mobile robot. The mobile robot is configured to emit an optical pattern. The charging apparatus includes a main body configured to perform charging of the mobile robot as the mobile robot docks with the charging apparatus, and two or more position markers located at the main body and spaced apart from each other. The position markers are configured to create indications distinguishable from a surrounding region when the optical pattern is emitted to surfaces of the position markers.

### CROSS-REFERENCE TO RELATED APPLICATION

This application claims priority under 35 U.S.C. §119 to Korean Patent Application No. 10-2013-0131623, filed on Oct. 31, 2013 in the Korean Intellectual Property Office, whose entire disclosure is incorporated herein by reference.

### BACKGROUND

1. Field

The present disclosure relates to a mobile robot having a self-charging function, a charging apparatus to charge the mobile robot, and a mobile robot system including the mobile robot and the charging apparatus.

2. Background

Generally, robots have been developed for various purposes. With recent expansion of robot application, household robots for use in common households are being manufactured. An example of household robots is a robot cleaner. The robot cleaner is a home appliance that performs cleaning by suctioning dust or other dirt while autonomously traveling about a zone to be cleaned. Such a robot cleaner typically includes a rechargeable battery and can travel autonomously. In the case of shortage of residual battery power or upon completion of cleaning, the robot cleaner autonomously travel to a charging apparatus that serves to charge the battery.

Generally, charging of the robot cleaner is performed by a method using infrared (IR) signals in which the robot cleaner having an infrared sensor senses two infrared signals emitted in different directions from the charging apparatus. However, this method allows the robot cleaner to detect only an approximate direction in which the charging apparatus is located rather than detecting an accurate position of the charging apparatus. Accordingly, the robot cleaner continuously senses two infrared signals during movement and frequently changes a traveling direction thereof from side to side in the course of accessing the charging apparatus. The robot cleaner cannot rapidly move to the charging apparatus and cause the robot cleaner to unintentionally apply push or bumping force to the charging apparatus during docking.

### BRIEF DESCRIPTION OF THE DRAWINGS

The embodiments will be described in detail with reference to the following drawings in which like reference numerals refer to like elements wherein:

FIG. 1 is a view showing the concept of acquiring position information of an obstacle using an optical pattern;

FIG. 2 is a block diagram schematically showing a configuration of a mobile robot according to one embodiment of the present disclosure;

FIG. 3 is a perspective view showing a robot cleaner as one example of a mobile robot;

FIG. 4 is a block diagram schematically showing a configuration of the robot cleaner shown in FIG. 3;

FIG. 5 shows views of a charging apparatus and a captured input image of the charging apparatus according to one embodiment of the present disclosure;

FIG. 6 shows views of a charging apparatus and a captured input image of the charging apparatus according to another embodiment of the present disclosure;

FIG. 7 shows a front view and a sectional view taken along line A-A showing a position marker array of a charging apparatus according to a further embodiment of the present disclosure;

FIG. 8 is a flowchart showing a method of controlling a robot cleaner according to one embodiment of the present disclosure; and

FIG. 9 is a flowchart showing a method of controlling a robot cleaner according to another embodiment of the present disclosure.

### DETAILED DESCRIPTION

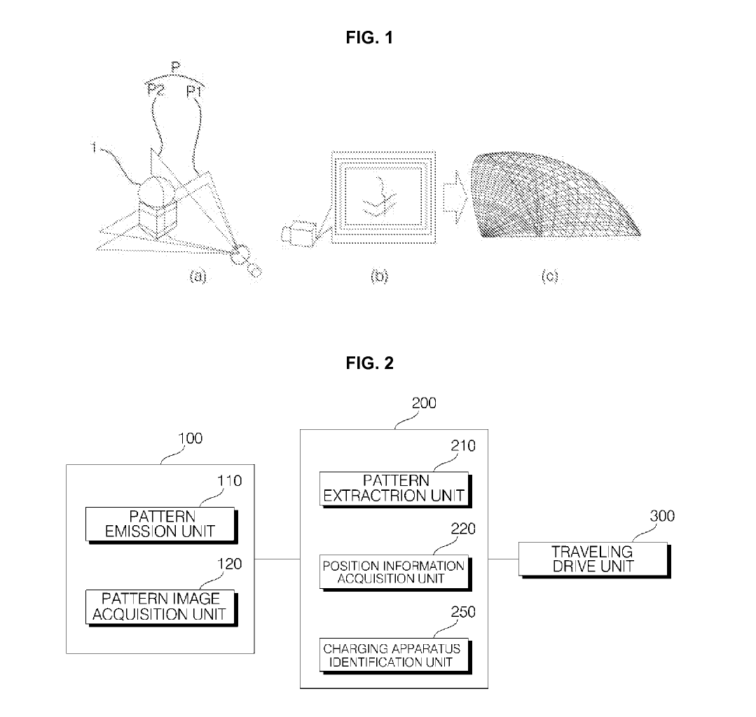

FIG. 1 is a view showing the general steps of acquiring position information of an obstacle using an optical pattern. Referring to FIG. 1, a mobile robot emits an optical pattern to a working area thereof (see FIG. 1(a)) and acquires an input image by capturing an image of the area to which the optical pattern is emitted (see FIG. 1(b)). The mobile robot may acquire 3-dimensional (3D) position information related to an obstacle 1 based on shapes, positions or other details of patterns extracted from the acquired input image (see FIG. 1(c)).

FIG. 2 is a block diagram schematically showing a configuration of a mobile robot according to one embodiment. Referring to FIG. 2, the mobile robot includes an optical pattern sensor 100, a controller 200, and a traveling drive unit 300.

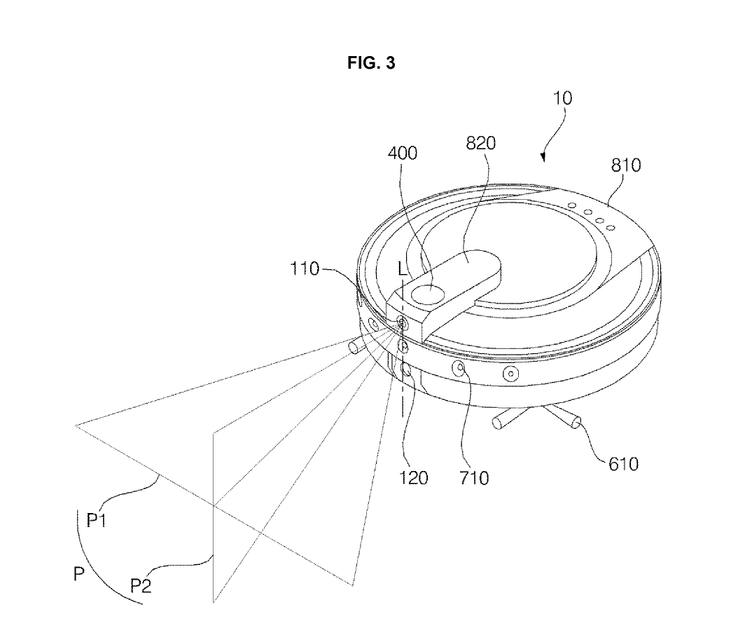

The optical pattern sensor 100 serves to emit an optical pattern to a working area of the mobile robot and to acquire an input image by capturing an image of the area to which the optical pattern is emitted. The optical pattern sensor 100 may be installed to a movable main body (see reference numeral 10 of FIG. 3) of the movable robot. The optical pattern may include a cross-shaped pattern P as exemplarily shown in FIG. 1(a). The optical pattern sensor 100 may include a pattern emission unit 110 to emit the optical pattern and a pattern image acquisition unit 120 to capture an image of an area to which the optical pattern is emitted.

The pattern emission unit 110 may include a light source and an optical pattern projection element (OPPE). The optical pattern is generated as light emitted from the light source penetrates the optical pattern projection element. For example, the light source may include Laser Diodes (LDs) or Light Emitting Diodes (LEDs). The light source may include laser diodes because laser beams are mono-chromatic, coherent and highly directional and, enable more precise distance measurement as compared to other light sources. Unlike laser beams or light, infrared or visible light has a greater deviation in the degree of precision with regard to measurement of a distance to an object according to various factors, such as color, material and the like, of the object. The optical pattern projection element may include a lens, a mask or a diffractive optical element (DOE).

The pattern emission unit 110 may emit light forward of the main body. For example light may be emitted slightly downward to ensure that the optical pattern is emitted to the floor within a working area of the mobile robot. To create a viewpoint for detection of a distance to an obstacle, an emission direction of the optical pattern and a major axis of a lens of the image acquisition unit 120 may have a prescribed angle rather than being parallel to each other.

The pattern image acquisition unit 120 acquires an input image by capturing an image of an area to which the optical pattern is emitted. The pattern image acquisition unit 120 may include a camera. The camera may obtain depth or surface information of the object in the acquired image based on structured light emitted on the object.

In the following description, points, lines, curves and the like, which constitute a pattern, are referred to as pattern expression elements. Based on this definition, a cross-shaped pattern may be seen as including two pattern expression elements, i.e. a horizontal line P1 and a vertical line P2 intersecting the horizontal line P1. There may be various combinations of horizontal lines and vertical lines, and the optical pattern may be composed of one horizontal line and a plurality of vertical lines intersecting the horizontal line.

The center of a lens of the pattern emission unit 110 and the center of the lens of the pattern image acquisition unit 120 may be arranged on a common vertical line (L of FIG. 3). In the input image, a vertical line pattern expression element remains at a consistent position, which may provide an accurate value of position information acquired based on a horizontal viewpoint relative to an obstacle.

The controller 200 may include a pattern extraction unit 210 to extract a pattern from the input image and a position information acquisition unit 220 to acquire position information related to an obstacle based on the extracted pattern. The pattern extraction unit 210 may compare brightness of points sequentially arranged in a horizontal direction in the input image to extract some of the points, i.e. candidate points, which are brighter than a surrounding region thereof by a given degree or more. Then, a line, drawn via vertical arrangement of the candidate points, may be referred to as a vertical line.

The pattern extraction unit 210 detects a cross-shaped pattern expression element that is defined by a vertical line and a line extending in a horizontal direction from the vertical line among lines drawn by the candidate points of the input image. The cross-shaped pattern expression element is not necessarily the entire cross-shaped pattern. While a pattern in the input image has a non-formulaic shape because a vertical line pattern and a horizontal line pattern may be deformed according to a shape of an object to which an optical pattern is emitted, a cross-shaped pattern expression element is always present at an intersection of a vertical line and a horizontal line although a size of the cross-shaped pattern expression element is variable according to a shape of the object. Accordingly, the pattern extraction unit 210 may extract a pattern expression element corresponding to a desired cross-shaped template from the input image and define the entire pattern including the pattern expression element.

The position information acquisition unit 220 may acquire information related to an obstacle, such as a distance to the obstacle, a width or height of the obstacle, and the like, based on the pattern extracted by the pattern extraction unit 210. When the pattern emission unit 110 emits an optical pattern to the floor where no obstacle is present, the pattern in the input image remains at a consistent position. In the following description, this input image is referred to as a reference input image. Position information of the pattern in the reference input image may be previously acquired based on triangulation. Assuming that an arbitrary pattern expression element Q, which constitutes a pattern in the reference input image, has coordinates Q(Xi, Y1), a distance from an actually emitted optical pattern to a point corresponding to the coordinates Q(Xi, Y1) has a known value.

On the other hand, in an input image acquired by emitting an optical pattern to an area where an obstacle is present, coordinates Q(Xi′, Yi′) of a pattern expression element may be displaced from the coordinates Q(Xi, Yi) in the reference input image. The position information acquisition unit 220 may acquire position information of the obstacle, such as a width and height of the obstacle, a distance to the obstacle, and the like, by comparing these coordinates.

The vertical displacement of a horizontal line pattern in an input image is variable according to a distance to an obstacle. Thus, as a distance from the mobile robot to an obstacle to which an optical pattern is emitted is reduced, a horizontal line pattern introduced to a surface of the obstacle is displaced upward in the resulting input image. In addition, a length of a vertical line pattern in an input image is variable according to a distance to an obstacle. Thus, as a distance from the mobile robot to an obstacle to which an optical pattern is emitted is reduced, a vertical line pattern in the resulting input image is increased in length.

As such, the position information acquisition unit 220 may acquire position information of an obstacle in real 3D space based on position information (for example, displacement and length variation) of a pattern extracted from an input image. Of course, although a horizontal line pattern in the input image may be vertically bent or folded rather than remaining without deformation according to the state of a surface of the obstacle to which an optical pattern is emitted because of a variable viewpoint relative to the pattern image acquisition unit 120, even in this case, position information of pattern expression elements constituting a pattern differs from that in a reference input image, which enables acquisition of 3D obstacle information based on actual distances, heights, widths and the like with regard to respective pattern expression elements.

The position information acquisition unit 220 acquires position information of a charging apparatus based on the pattern extracted via the pattern extraction unit 210. The charging apparatus may include two or more position markers spaced apart from each other. The position markers may create indications distinguishable from a surrounding region thereof when an optical pattern emitted from the mobile robot is emitted to surfaces thereof. The pattern extraction unit 210 may extract the indications created by the position markers from the input image acquired by the pattern image acquisition unit 120, and the position information acquisition unit 220 may acquire position information of the indications. Since the position information contains positions of the indications in 3D space that are acquired by considering an actual distance from the mobile robot to the indications, the actual distance from the mobile robot to the indications may also be acquired upon acquisition of the position information. A charging apparatus identification unit 250 may acquire position information of the charging apparatus by comparing an actual distance between the indications with a predetermined reference value.

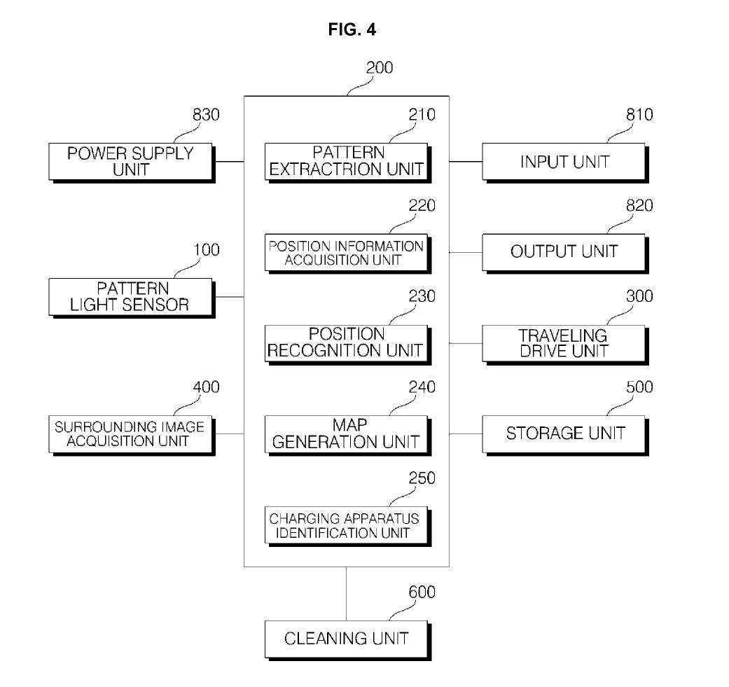

FIGS. 3 and 4 show a robot cleaner as one example of a mobile robot. The robot cleaner may further include a surrounding image acquisition unit 400 to acquire image information by capturing an image of a surrounding area. The surrounding image acquisition unit 400 may include at least one camera installed to face upward and/or forward. As a general example, a camera sensor is installed to face upward. The camera may include a lens having a wide angle of view to capture an image of a wide area around the robot cleaner.

A position recognition unit 230 may extract a characteristic point from the image captured by the surrounding image acquisition unit 400 and recognize a position of the robot cleaner on the basis of the characteristic point. A map generation unit 240 may generate a map of a surrounding area, i.e. a map related to a cleaning space based on the position of the robot cleaner recognized by the position recognition unit 230. The map generation unit 240 may generate a map of a surrounding area, which contains the situation of an obstacle, in cooperation with the position information acquisition unit 220.

The traveling drive unit 300 may include a wheel motor to drive one or more wheels installed at the bottom of the main body 10 of the robot cleaner. The traveling drive unit 300 serves to move the main body 10 of the robot cleaner in response to a drive signal. The robot cleaner may include left and right drive wheels and the traveling drive unit 300 may include a pair of wheel motors to rotate the left drive wheel and the right drive wheel, respectively.

These wheel motors may be rotated independently of each other, and the robot cleaner may perform traveling direction change according to rotation directions of the left drive wheel and the right drive wheel. In addition, the robot cleaner may further include an auxiliary wheel to support the main body 10 of the robot cleaner. The auxiliary wheel may serve to minimize friction between a lower surface of the main body 10 of the robot cleaner and the floor and to ensure smooth movement of the robot cleaner.

The robot cleaner may further include a storage unit or memory 500. The storage unit 500 may store an input image, obstacle information, position information, a map of a surrounding area, and the like. The storage unit 500 may also store control programs to drive the robot cleaner and data associated with the control programs. The storage unit 500 mainly utilizes a non-volatile memory (NVM or NVRAM). The non-volatile memory is a storage device that continuously maintains stored information even when there is no power. Examples of the non-volatile memory may include a ROM, a flash memory, a magnetic recording medium (for example, a hard disc, a disc drive or a magnetic tape), an optical disc drive, a magnetic RAM, a PRAM, or the like.

The robot cleaner may further include a cleaning unit 600 to suction dust or other dirt from a surrounding area. The cleaning unit 600 may include a dust container in which collected dust is stored, a suction fan to provide power for suction of dust from a cleaning area, and a suction motor to rotate the suction fan for suction of air. The cleaning unit 600 may include a rotating brush that is rotated about a horizontal axis at the bottom of the main body 10 of the robot cleaner to cause dust on the floor or a carpet to be floating in the air. A plurality of blades may be arranged in a spiral direction at the outer circumference of the rotating brush. The robot cleaner may further include a side brush that is rotated about a vertical axis and serves to clean the wall surface, the corner, and the like. The side brush may be located between the neighboring blades.

The robot cleaner may include an input unit or interface 810, an output unit or interface 820, and a power supply unit 830. The robot cleaner may receive a variety of control commands required for general operations of the robot cleaner via the input unit 810. For example, the input unit 810 may include a confirmation button, a setting button, a reservation button, a charging button and the like.

The confirmation button may be used to input a command to confirm obstacle information, position information, image information, a cleaning area or a cleaning map. The setting button may be used to input a command to set or change a cleaning mode. The reservation button may be used to input reservation information. The charging button may be used to input a command to return the robot cleaner to the charging apparatus that serves to charge the power supply unit 830. The input unit 810 may include hard keys, soft keys, a touch pad and the like for providing input. The input unit 810 also may take the form of a touchscreen that further has a function of the output unit 820 that will be described below. The input unit 810 may provide modes that the user can select, such as, for example, a charging mode and a diagnosis mode. The charging mode and the diagnosis mode will be described below in detail.

The output unit or interface 820 displays reservation information, a battery state, an intensive cleaning mode, a space expansion mode, a zigzag mode, a traveling mode, and the like on a screen thereof. The output unit 820 may output operating states of respective components of the robot cleaner. In addition, the output unit 820 may display obstacle information, position information, image information, an internal map, a cleaning area, a cleaning map, a designated area, and the like. The output unit 820 may include a Light Emitting Display (LED) panel, a Liquid Crystal Display (LCD) panel, a plasma display panel, an Organic Light Emitting Diode (OLED) panel, or the like.

The power supply unit 830 serves to supply power required for operation of respective components, and may include a rechargeable battery. The power supply unit 830 serves to supply power required to drive respective components and operating power required for traveling and cleaning. Upon shortage of residual power, the robot cleaner will move to the charging apparatus for battery charging. The power supply unit 830 may further include a battery sensing unit to sense a battery charging rate. The controller 200 may display residual battery power or a battery charging rate via the output unit 820 based on results sensed by the battery sensing unit.

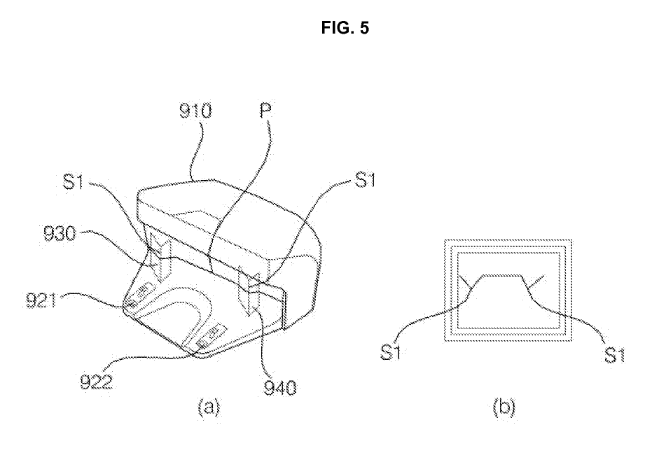

FIGS. 5(a) and 5(b) are views respectively showing a charging apparatus and a captured input image of the charging apparatus according to one embodiment of the present disclosure. Referring to FIG. 5(a), the charging apparatus includes a charging apparatus main body 910 having charging terminals 921 and 922 to supply power required to charge the robot cleaner, and two or more position markers 930 and 940 arranged at the charging apparatus main body 910. The position markers 930 and 940 are spaced apart from each other by a given distance. In the following description, when it is necessary to distinguish these position markers 930 and 940 from each other, one position marker located at the left side when viewed from the front of the charging apparatus main body 910 is referred to as a left position marker 930 and the other position marker located at the right side is referred to as a right position marker 940.

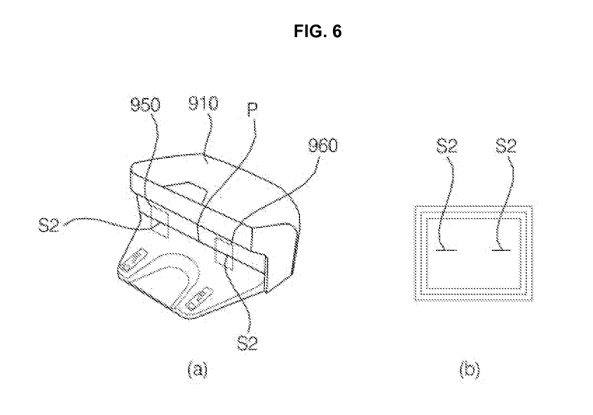

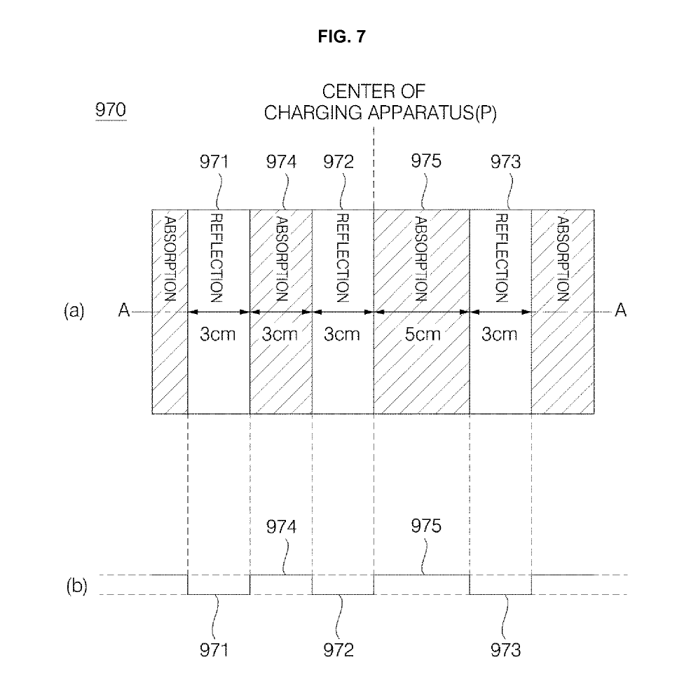

Such a position marker creates an indication distinguishable from a surrounding region when an optical pattern emitted from the robot cleaner is emitted to a surface thereof. The indication may be created as the optical pattern emitted to the surface of the position marker is deformed based on morphological characteristics of the position marker and, differently, may be created by a difference of light reflectivity (or light absorptivity) between the position marker and a surrounding region due to material characteristics of the position marker (see FIGS. 6 and 7).

Referring to FIG. 5, each of the position markers 930 and 940 may include a corner S1 to enable formation of an indication. As an optical pattern emitted to a surface of the position marker 930 or 940 is refracted by an angle at the corner S1, a cusp S1 as an indication is displayed in an input image.

The corner S1 may protrude in an introduction direction of the optical pattern. FIG. 5(b) shows an input image acquired when an optical pattern P in the form of a horizontal line, emitted forward of the robot cleaner, is introduced to the position markers 930 and 940 that protrude in an introduction direction of the optical pattern. As will be appreciated from the input image, the cusps S1 are located lower than lines connected to the cusps S1 in the image due to a viewpoint difference depending on distance.

The robot cleaner may automatically perform charging apparatus search upon shortage of residual battery power and, differently, may perform charging apparatus search when the user inputs a charging command via the input unit 810. When the robot cleaner performs charging apparatus search, the pattern extraction unit 210 extracts the cusps S1 from the input image, and the position information acquisition unit 220 acquires position information of the extracted cusps S1. The position information may include a position in 3D space that is acquired by considering a distance from the robot cleaner to each of the cusps S1.

The charging apparatus identification unit 250 calculates an actual distance between the cusps S1 based on the position information related to the cusps S1 acquired via the position information acquisition unit 220, and compares the actual distance with a predetermined reference value, thereby judging that the charging apparatus is searched when a difference between the actual distance and the reference value is within a given range. As the robot cleaner is moved to the searched charging apparatus by the traveling drive unit 300 and thereafter performs docking, charging may be performed.

FIGS. 6(a) and 6(b) are views respectively showing a charging apparatus and a captured input image of the charging apparatus according to another embodiment of the present disclosure. Referring to FIG. 6, surfaces of position markers 950 and 960 to which an optical pattern P is introduced may be formed of a material having greater light reflectivity than a surrounding region. The position markers 950 and 960 may be formed by applying paint that is capable of increasing light reflectivity, or by attaching a light reflection film. The surfaces of the position markers 950 and 960 may be flat.

Patterns in an input image, located over the position markers 950 and 960, (hereinafter referred to as position marker patterns S2) are brighter than a surrounding region. Therefore, the pattern extraction unit 210 may extract the position marker patterns based on a brightness difference with the surrounding region, and the position information acquisition unit 220 may acquire position information of the extracted left and right position marker patterns. The surrounding region of the charging apparatus main body 910 around the position markers 950 and 960 may be formed of a light absorption material.

The charging apparatus identification unit 250 calculates an actual distance between the position marker patterns P2 based on the position information, and compares the actual distance with a predetermined reference value, thereby judging that the charging apparatus is searched when a difference between the actual distance and the reference value is within a given range. In this case, the actual distance may be calculated based on a distance between a width direction center of the left position marker pattern S2 and a width direction center of the right position marker pattern S2. Then, as the robot cleaner is moved to the searched charging apparatus by the traveling drive unit 300 and thereafter performs docking, charging may be performed.

FIGS. 7(a) and 7(b) are respectively a front view and a sectional view taken along line A-A showing a position marker array of a charging apparatus according to a further embodiment of the present disclosure. Referring to FIG. 7, the main body 910 may include a position marker array 970. The position marker array 970 may include two or more light reflection surfaces 971, 972 and 973, and light absorption surfaces 974 and 975 located between the light reflection surfaces 971, 972 and 973. Here, the light reflection surfaces 971, 972 and 973 correspond to position markers. The light reflection surfaces 971, 972 and 973 must have sufficient light reflectivity to ensure extraction of position marker patterns (via absorption of an optical pattern emitted to the light absorption surfaces) from an input image although they do not perform total reflection.

The light absorption surfaces 974 and 975 serve to absorb a given amount of introduced light or more. An optical pattern emitted to the absorption surfaces 974 and 975 must cause a sufficient brightness difference with respect to the position marker patterns in the input image. Preferably, the optical pattern emitted to the absorption surfaces 974 and 975 is not visible in the acquired input image.

The light reflection surfaces 971, 972 and 973 preferably protrude more in an introduction direction of the optical pattern than the light absorption surfaces 974 and 975. As exemplarily shown in FIG. 7(b), the position marker array 970 may have a convex and concave cross sectional shape.

The light absorption surfaces 974 and 975 may have a different horizontal width from a horizontal width of the light reflection surfaces 971, 972 and 973. FIG. 7 shows the light absorption surface 975 as having a different width (5 cm) from a width (3 cm) of the light reflection surfaces 971, 972 and 973.

On the basis of a vertical reference line P that is a docking reference line of the robot cleaner, the light reflection surface 972 may be located at one of left and right sides of the vertical reference line and the light absorption surface 975 may be located at the other side. The vertical reference line may be located at the center of the charging apparatus. The charging terminals 921 and 922 may be equidistantly located respectively at both sides of the vertical reference line.

The position marker array 970 may include a first light reflection surface 971, a second light reflection surface 972 and a third light reflection surface 973, which are position markers. The first light reflection surface 971, the second light reflection surface 972 and the third light reflection surface 973 are sequentially arranged in the horizontal direction. A first light absorption surface 974 may be located between the first light reflection surface 971 and the second light reflection surface 972, and a second light absorption surface 975 may be located between the second light reflection surface 972 and the third light reflection surface 973. The second light absorption surface 975 may have a different horizontal width from that of the first light absorption surface 974. The first light absorption surface 974 and the second light absorption surface 975 may be located respectively at both sides of the vertical reference line.

The pattern extraction unit 210 of the robot cleaner may extract position marker patterns based on a brightness difference with a surrounding region, and the position information acquisition unit 220 may acquire position information of the extracted position marker patterns.

The charging apparatus identification unit 250 may obtain information related to relative positions between position marker patterns that are created by the position markers 971, 972 and 973 based on the position information. The charging apparatus identification unit 250 may calculate actual distances between the position marker patterns. The charging apparatus identification unit 250 compares the actual distances with predetermined reference values, thereby judging that the charging apparatus is searched when differences between the actual distances and the reference values are within a given range. In such a case, the actual distances may include a distance between the first light reflection surface 971 and the second light reflection surface 972 and a distance between the second light reflection surface 972 and the third light reflection surface 973, which are different from each other. In this case, different reference values (e.g., 3 cm and 5 cm) may be used for comparison with the respective actual distances.

Similar to the above-described embodiment, actual distances between the position marker patterns in the input image may be calculated based on a distance between width direction centers of the position marker patterns. As the robot cleaner is moved to the searched charging apparatus by the traveling drive unit 300 and thereafter performs docking, charging may be performed.

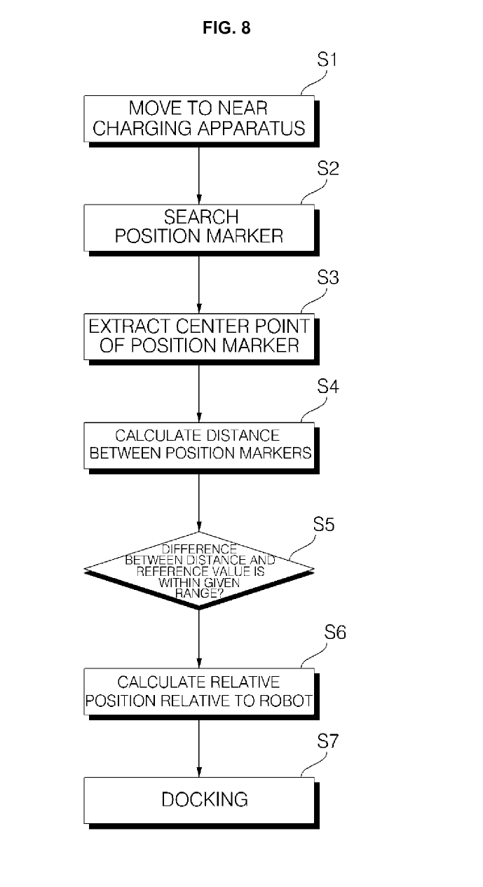

FIG. 8 is a flowchart showing a method of controlling a robot cleaner according to one embodiment of the present disclosure. Referring to FIG. 8, the robot cleaner may include a charging mode. The charging mode may be automatically performed when residual battery power becomes a given level or less and, differently, may be performed by a user command input via the input unit 810.

In the charging mode, the robot cleaner autonomously travels for charging apparatus search (S1). This traveling may be randomly performed until the charging apparatus is searched. Differently, the robot cleaner may access a position of the charging apparatus that has previously been searched and stored in a map stored in the map generation unit 240.

Position markers of the charging apparatus are searched (S2). An optical pattern is emitted and an input image of an area to which the optical pattern is emitted is captured. With regard to two or more position marker patterns in the input image corresponding to the position markers, center points of the position marker patterns in the horizontal width direction are extracted (S3).

Actual distances between the position marker patterns are calculated based on distances between the center points of the position marker patterns in the horizontal width direction (S4). The actual distances are compared with reference values (S5). When differences between the actual distances and the reference values are within a given range, this means that the charging apparatus has been located. Thus, a position of the charging apparatus relative to the robot cleaner is calculated (S6), and movement of the robot cleaner is performed based on the calculated relative position to perform docking with the charging apparatus (S7).

On the other hand, when it is judged in step S5 that differences between the actual distances and the reference values are not within a given range, this means that the charging apparatus has not been located. Thus, the control method returns to step S1 or step S2 to cause the robot cleaner to research a position of the charging apparatus.

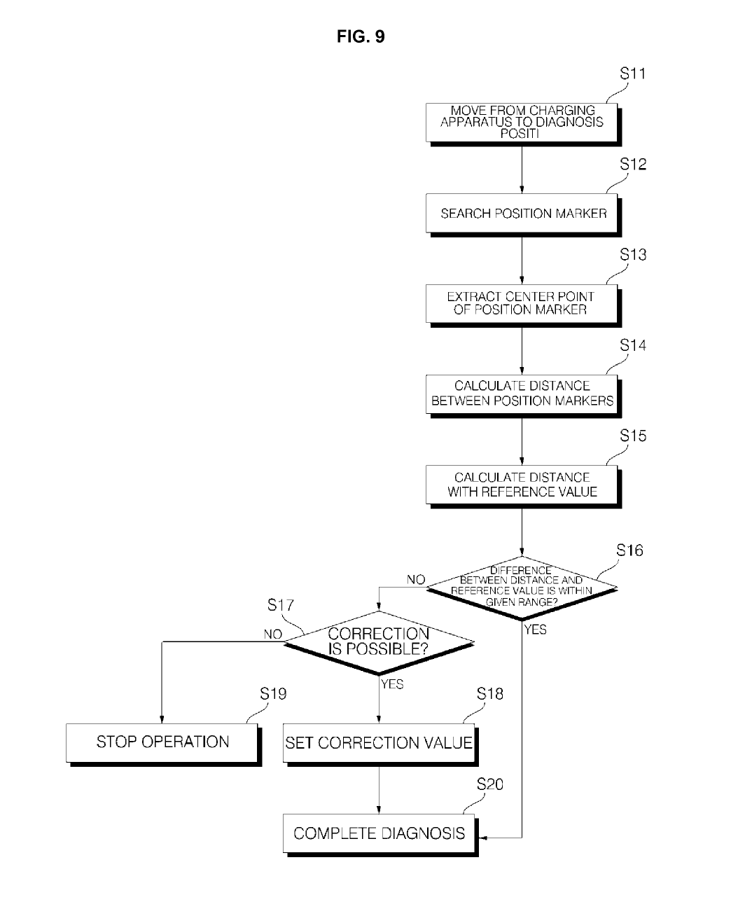

FIG. 9 is a flowchart showing a method of controlling a robot cleaner according to another embodiment of the present disclosure. Referring to FIG. 9, the robot cleaner may provide a diagnosis mode. The diagnosis mode is performed in a state in which the robot cleaner docks with the charging apparatus. The diagnosis mode may be automatically performed according to a predetermined algorithm when a given condition (for example, lapse of a given time in such a docking state) is satisfied and, differently, may be performed by a user command input via the input unit 810.

Upon implementation of the diagnosis mode, the robot cleaner is separated from the charging apparatus and moves to a predetermined diagnosis position (S11). The robot cleaner searches position markers of the charging apparatus at the diagnosis position (S12). An optical pattern is emitted and an input image of an area to which the optical pattern is emitted is captured.

Two or more position marker patterns corresponding to the position markers are extracted from the input image, and center points of the extracted position marker patterns in the horizontal width direction are extracted (S13). Relative distances between the position marker patterns are calculated based on distances between the center points of the position marker patterns in the horizontal width direction (S14). The relative distances may be distances between the position marker patterns in the input image and, differently, may be converted values of actual distances between the position markers of the charging apparatus.

The relative distances are compared with reference values (S15). When differences between the relative distances and the reference values are within a given range (S16), this means that a component for charging apparatus search, such as a camera sensor or the like, is normally operated. Thus, the diagnosis mode is completed and switching to a predetermined cleaning mode or charging mode is performed (S20). Conversely, when differences between the relative distances and the reference values are not within a given range, the robot cleaner judges whether or not this situation is correctable (S17). For example, whether or not differences between the relative distances and the reference values are within a predetermined correctable range is judged.

When differences between the relative distances and the reference values are within the predetermined correctable range, a correction value is set (S17 and S18). The correction value may be proportional to differences between the relative distances and the reference values. The set correction value is reflected in the reference values from the next charging apparatus search time. For example, when the relative distance is greater than the reference value, the reference value is renewed to a new value that is increased in proportion to the correction value. In the converse case, the reference value is renewed to a new value that is reduced in proportion to the correction value. The diagnosis mode is completed and switching to a predetermined cleaning mode or charging mode is performed (S16 and S20).

Meanwhile, when the differences between the relative distances and the reference values deviate from the correctable range in step S17, that the component for charging apparatus search is not normally operated is judged, and operation of the robot cleaner stops (S19). For example, this corresponds to deterioration and malfunction of the camera sensor and, in this case, the robot cleaner may display occurrence of errors via the output unit 820 to assist the user in perceiving occurrence of errors, and the user having confirmed this may take an appropriate measure, such as a request for after-service.

A mobile robot of the present disclosure may accurately detect a position of a charging apparatus.

Another object of the present disclosure is to provide a mobile robot system which may provide smooth charging of a mobile robot.

A further object of the present disclosure is to provide a mobile robot which has a self-diagnosis function to autonomously diagnose charging apparatus sensing ability thereof.

In accordance with an embodiment of the present disclosure, the above and other objects can be accomplished by the provision of a charging apparatus configured to charge a mobile robot, the mobile robot being configured to emit an optical pattern, the charging apparatus including a charging apparatus main body configured to perform charging of the mobile robot as the mobile robot docks with the charging apparatus and two or more position markers located at the charging apparatus main body and spaced apart from each other, the position markers being configured to create indications distinguishable from a surrounding region when the optical pattern is emitted to surfaces of the position markers.

The position markers may include a corner configured to enable creation of the indication as the optical pattern introduced to the surface of the position marker is refracted by an angle. The corner may vertically extend.

Each of the position markers may have higher reflectivity at the surface thereof, to which the optical pattern is introduced, than the surrounding region. The surface of the position marker may be flat.

Each of the position markers may include two or more light reflection surfaces corresponding to the indication and a light absorption surface located between the neighboring light reflection surface. The light reflection surfaces may protrude more than the light absorption surface in an emission direction of the optical pattern. The light absorption surface may have a horizontal width different from a horizontal width of the light reflection surfaces. The horizontal width of the light absorption surface may be greater than the horizontal width of the light reflection surfaces.

On the basis of a prescribed vertical reference line corresponding to a reference docking point of the mobile robot, one of the light reflection surfaces may be located at one of the left and right sides of the vertical reference line and the light absorption surface may be located at the other side. The position marker may include a first light reflection surface, a second light reflection surface, and a third light reflection surface, each the first light reflection surface, the second light reflection surface, and the third light reflection surface corresponding to the indication respectively, and being sequentially arranged in a horizontal direction, a first light absorption surface located between the first light reflection surface and the second light reflection surface and a second light absorption surface located between the second light reflection surface and the third light reflection surface, the second light absorption surface having a horizontal width different from a horizontal width of the first light absorption surface.

In accordance with another embodiment of the present disclosure, there is provided a mobile robot including a pattern emission unit configured to emit an optical pattern including a horizontal line pattern, a pattern image acquisition unit configured to acquire an input image by capturing an image of an area to which the optical pattern is emitted, a pattern extraction unit configured to extract two or more position marker patterns spaced apart from each other from the input image, a position information acquisition unit configured to acquire a distance between the position marker patterns extracted by the pattern extraction unit and a charging apparatus identification unit configured to identify a charging apparatus by comparing the distance between the position marker patterns with a predetermined reference value.

Each of the position marker patterns may have a cusp. Each of the position marker patterns may be a line having a prescribed length in a horizontal direction.

In accordance with a further embodiment of the present disclosure, there is provided a mobile robot system including a mobile robot configured to emit a prescribed optical pattern and a charging apparatus configured to charge the mobile robot, wherein the charging apparatus includes two or more position markers spaced apart from each other by a given distance, the position markers being configured to create indications distinguishable from a surrounding region when the optical pattern emitted from the mobile robot is introduced to surfaces of the position markers.

Each of the position markers may include a corner configured to enable creation of the indication as the optical pattern introduced to the surface of the position marker is refracted by an angle. The corner may vertically extend.

Each of the position markers may have higher reflectivity at the surface thereof, to which the optical pattern is introduced, than the surrounding region. The surface of the position marker may be flat.

Each of the position markers may include two or more light reflection surfaces corresponding to the indication and a light absorption surface located between the neighboring light reflection surface.

This application is related to U.S. application Ser. No. 14/529,742 (Attorney Docket No. PBC-0471) filed on Oct. 31, 2014, whose entire disclosure is incorporated herein by reference.

Although the embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in components and/or arrangements of the subject combination arrangement within the scope of the disclosure, the drawings and the appended claims. In addition to variations and modifications in the components and/or arrangements, alternative uses will also be apparent to those skilled in the art.

Any reference in this specification to “one embodiment,” “an embodiment,” “example embodiment,” etc., means that a particular feature, structure, or characteristic described in connection with the embodiment is included in at least one embodiment of the disclosure. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

What is claimed is:

1. A charging apparatus configured to charge a mobile robot, the mobile robot being configured to emit an optical pattern, the charging apparatus comprising:
a main body configured to perform charging of the mobile robot as the mobile robot docks with the charging apparatus; and
at least two position markers located at the charging apparatus main body and spaced apart from each other, the position markers being configured to create indications distinguishable from a surrounding region when the optical pattern is emitted to surfaces of the position markers.

2. The charging apparatus according to claim 1, wherein each of the position markers includes a corner configured to enable creation of the indication as the optical pattern directed to the surface of the position marker is refracted by an angle.

3. The charging apparatus according to claim 2, wherein the corner extends in a vertical direction.

4. The charging apparatus according to claim 1, wherein each of the position markers has higher reflectivity at the surface thereof, to which the optical pattern is directed, than the surrounding region.

5. The charging apparatus according to claim 4, wherein the surface of the position marker is flat.

6. The charging apparatus according to claim 1, wherein the position markers includes:
at least two light reflection surfaces corresponding to the indication; and
a light absorption surface located between neighboring light reflection surfaces.

7. The charging apparatus according to claim 6, wherein the light reflection surfaces protrude more than the light absorption surface in a direction of the optical pattern emission.

8. The charging apparatus according to claim 6, wherein the light absorption surface has a horizontal width different from a horizontal width of the light reflection surfaces.

9. The charging apparatus according to claim 8, wherein the horizontal width of the light absorption surface is greater than the horizontal width of the light reflection surfaces.

10. The charging apparatus according to claim 6, wherein, based on a prescribed vertical reference line corresponding to a reference docking point of the mobile robot, one of the light reflection surfaces is located at the left and the other at the right side of the vertical reference line and the light absorption surface is located at one of left and right sides.

11. The charging apparatus according to claim 8, wherein the position marker includes:
a first light reflection surface, a second light reflection surface, and a third light reflection surface, each the first light reflection surface, the second light reflection surface, and the third light reflection surface corresponding to the indications and being arranged in a horizontal direction;
a first light absorption surface located between the first light reflection surface and the second light reflection surface; and
a second light absorption surface located between the second light reflection surface and the third light reflection surface, the second light absorption surface having a horizontal width different from a horizontal width of the first light absorption surface.

12. A mobile robot comprising:
a pattern emission laser configured to emit an optical pattern including a horizontal line pattern;
a pattern image acquisition unit configured to acquire an input image by capturing an image of an area to which the optical pattern is emitted;
a pattern extraction unit configured to extract two or more position marker patterns spaced apart from each other from the input image;
a position information acquisition unit configured to acquire a distance between the position marker patterns extracted by the pattern extraction unit; and
a charging apparatus identification unit configured to identify a charging apparatus by comparing the distance between the position marker patterns with a predetermined reference value.

13. The mobile robot according to claim 12, wherein each of the position marker patterns has a cusp.

14. The mobile robot according to claim 12, wherein each of the position marker patterns is a line having a prescribed length in a horizontal direction.

15. A mobile robot system comprising:
a mobile robot configured to emit a prescribed optical pattern; and
a charging apparatus configured to charge the mobile robot,
wherein the charging apparatus includes at least two position markers spaced apart from each other by a given distance, the position markers being configured to create indications distinguishable from a surrounding region when the optical pattern emitted from the mobile robot is directed to surfaces of the position markers.

16. The mobile robot system according to claim 15, wherein each of the position markers includes a corner configured to enable creation of the indication as the optical pattern directed to the surface of the position marker is refracted by an angle.

17. The mobile robot system according to claim 16, wherein the corner extends in a vertical direction.

18. The mobile robot system according to claim 15, wherein each of the position markers has higher reflectivity at the surface thereof, to which the optical pattern is directed, than the surrounding region.

19. The mobile robot system according to claim 18, wherein the surface of the position marker is flat.

20. The mobile robot system according to claim 15, wherein each of the position markers includes:
at least two light reflection surfaces corresponding to the indication; and
a light absorption surface located between the neighboring light reflection surface.
